(19) United States
(12) Patent Application Publication
(10) Pub. No.: US 2008/0233229 A1
(43) Pub. Date: Sep. 25, 2008

(54) Apparatus and method for producing containers

(75) Inventors: Wayne Grant Leslie, Logan Township, IN (US); Giovanni Battista De Amicis, Cincinnati, OH (US); Patrick John Healey, West Chester, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: The Procter & Gamble Company

(21) Appl. No.: 11/726,455

(22) Filed: Mar. 22, 2007

(51) Int. Cl. B28B 17/00; B29C 44/54

(52) U.S. Cl. 425/150; 264/225

(57) ABSTRACT

Method and apparatus for the production of containers are disclosed. A container blow molding element can concurrently produce a plurality of containers. Two adjacent containers are disposed a first distance apart. A container conveying element can receive the plurality of containers at predetermined container locations. The predetermined container locations corresponding to the two adjacent containers are disposed a second distance apart. A transition element can transfer the plurality of containers from the blow molding element to the container conveying element. The distance between the two adjacent containers is altered from the first distance to the second distance after the plurality of containers is removed from the blow molding element and before the plurality of containers is received by the container conveying element.

### FIELD OF THE INVENTION

The disclosure relates to the production and subsequent handling of containers. The disclosure relates particularly to the production and handling of blow molded containers.

### BACKGROUND OF THE INVENTION

Blow molded containers are used as an efficient means of packaging a wide range of consumer products. In some applications, containers are blow molded in a first operation and accumulations of blow molded containers are subsequently provided as a raw material to a filling process. In these applications, the containers are blow molded and stored until they are required for filling. This requires that the containers be handled and stored between the blow molding of the container and the subsequent processing of the containers into a finished product. This requires personnel, equipment and facilities dedicated to the handling and storage of containers.

There is a need for an apparatus and method allowing for the direct, but flexible, coupling of the blow molding equipment with the packaging equipment. There is an additional need for an apparatus which allows for additional production flexibility by offering the capacity to concurrently produce multiple products.

### BRIEF DESCRIPTION OF THE DRAWINGS

FIG. 1 is a schematic plan view of a container production and filling system according to an embodiment of the invention.

FIG. 2 is a schematic side view of a portion of an embodiment of the invention.

### DETAILED DESCRIPTION OF THE INVENTION

Markush language as used herein encompasses combinations of the individual Markush group members, unless otherwise indicated.

All numerical ranges disclosed herein, are meant to encompass each individual number within the range and to encompass any combination of the disclosed upper and lower limits of the ranges.

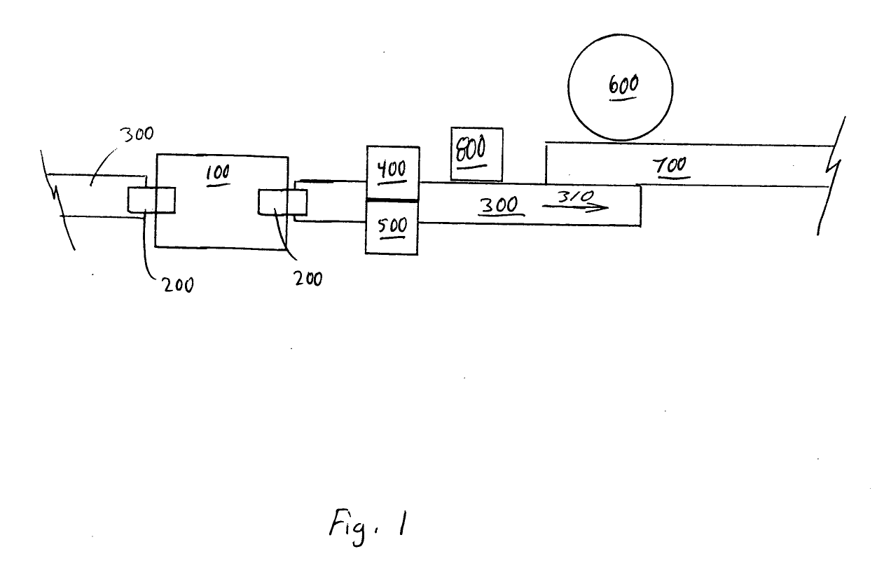

As illustrated in FIG. 1, an apparatus 1000 for producing containers 110. The apparatus 1000 comprises a container forming element 100, which element can concurrently produce a plurality of containers 10. The container forming element 100 may comprise a blow molding element configured to produce containers 110 located on predetermined container center lines such that at least two adjacent containers 110 are disposed a first predetermined distance apart. The blow molding element may be of the shuttle type as is known in the art. A shuttle blow molder may be single sided or dual sided. The number of containers produced by a given cycle of the blow molder is determined by the configuration of the extrusion die and the corresponding container molds. An exemplary blow molding machine is the electric blow molding machine, model EP-LS-8/D-XL, available from Magic MP of Italy. The container forming element may produce containers through extrusion blow molding, stretch blow molding or other blow molding methods as are known in the art.

The container forming element 100 produces containers on fixed, predetermined centers. The spacing of the container centers may vary with the number of container cavities in the mold. The blown containers may be made available at the discharge of the machine spaced apart at the container center spacing of the mold.

In one embodiment the container forming element 100 may comprise an in-mold-labeling system as is known in the art.

To improve the uniformity of the operation of the subsequent container handling equipment, it may be desirable to alter the spacing of the containers from the mold based spacing to a predetermined spacing associated with the downstream packaging operations to be performed subsequent to the blow molding of the containers. In this manner, the handling of containers from disparate molding centers and from molds of differing mold cavity numbers may be handled in a consistent manner downstream of the container forming element 100.

In one embodiment, containers 110 are made available in the container forming element 100 after the containers have been leak tested. At this point, the containers are spaced apart at the mold cavity spacing. The containers 110, are acquired from this location by a container transition element 200. The transition element 200 removes the containers from the container forming element 100 and transfers them to a conveying element 300. The transition element alters the spacing of the containers 110 from the mold cavity spacing to the container conveying element spacing. The conveying element 300 comprises at least two container receiving stations 310 disposed a predetermined distance apart. The containers 110 are deposited by the transition element 200 into the container receiving stations 310.

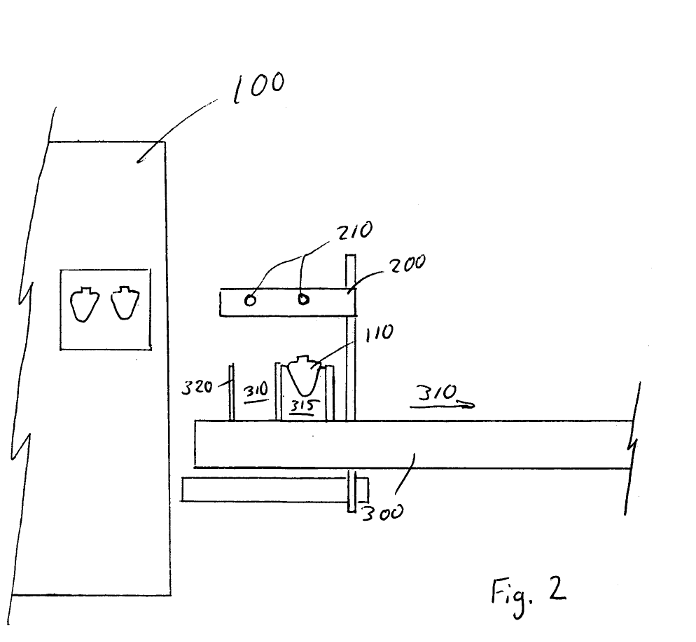

In one embodiment the transition from the mold cavity spacing to the container receiving station spacing may be accomplished by means of a mechanism as illustrated in FIG. 2. According to the figure, a plurality of container picking stations 210 corresponding in number to the number of containers blow molded per cycle, are disposed along a common linear path such that the container picking elements may be placed in sufficient proximity to the plurality of containers in the container forming element 100 to allow the picking stations 210 to acquire the plurality of containers 110. The picking stations 210 may be separated by compression springs which are placed in compression by the extension of an extension element. The operation of the extension element compresses each of the springs and disposes the picking stations 210 at a spacing about that of the mold spacing. The extension element 220 may comprise a pneumatic, mechanical, hydraulic or electric extension element translatable between a first position and a second position.

Subsequent to the acquisition of the plurality of containers 110 by the picking stations 210, the transition element 200 moves the picking stations 210 and containers 110 from a picking position to a placing position. Subsequent to the acquisition of the containers 110 but prior to the release of the containers 110, the extension element retracts and allows the compressed springs to expand and to dispose the picking stations to the spacing of the container receiving stations 310 of the conveying element 300.

In one embodiment the picking station elements may each be affixed to a distinct cam following element. The cam following elements may follow a cam path which disposes the picking elements at the mold cavity spacing when the picking elements are disposed to acquire the containers from the container forming element 100, and may follow the cam track such that the picking elements 210 are disposed at the spacing of the container receiving stations 310 of the conveying element 300 when the picking element dispose the plurality of containers 110 to the container receiving stations 310.

The translation of the transition element 200 from the picking position to the placing position may be facilitated by any such translation means known in the art including but not limited to, rolling element chain conveying, pneumatic or hydraulic actuator, electric actuator, or other suitable translation means as are known in the art. The actuator may be designed according to the desired path between the picking station and the placing station. The path may be linear, arcurate or a combination of linear and arcurate segments to move the picking stations 210 from the picking position to the placing position with the desired level of positional accuracy.

In one embodiment the path of the picking station elements 210 may comprise a horizontal segment which translates the picking elements 210 from a position beyond the confines of the container forming element 100, to a position from which the plurality of containers may be acquired and then back to the first position. The path may further comprise a vertical segment which translates the picking stations from a first position along the horizontal path segment to a second position from which the plurality of containers 10 may be transferred to the container receiving stations of the conveying element 300 and back to the first position.

Each of the particular picking stations may comprise a picking element for acquiring a container 110 from the blow molding element with sufficient control of the container 110 to enable the reliable translation of the container 10 from the container forming element 100 to the conveying element 300 without losing control or dropping the container 110. Such picking elements may comprise a vacuum attachment means such as a suction cup coupled to a vacuum source, a mechanical grasping mechanism able to at least partially encircle and apply sufficient compressive force to the container to acquire control of the containers location, or other container acquisition means as are known in the art.

The container receiving stations 310 may comprise a container stabilizing element. In one embodiment, the container stabilizing element comprises a pair of opposed flights. Each pair of flights delimits a particular container receiving station. The pair comprises a rear flight and a front flight. The relative spacing of each pair of flights may be adjusted. The flights may be configured such that the rear flights may be moved relative to the position of the front flights. In one embodiment the flights may be configured such that the front flights may be moved relative to the position of the rear flights. In another embodiment, each of the front and rear flights may be configured to move equally relative to a center position between the flights. The pairs of flights are configured to move from a first location where the transitions element 200 deposits a plurality of containers into the receiving stations of the conveying element 300, to a subsequent location where a packaging operation may be performed upon the received containers 10.

Conveying element 300 may comprise container stabilizing elements 320. Container stabilizing elements 320 may comprise lugged belts. The lugs may have profiles which approximate those of the containers 110. The lugs may comprise relatively soft and resilient materials which readily conform to the profile of the container as the containers are compressed between a pair of such lugs or a lug and affixed rail.

The container stabilizing elements may comprise articulating clamps fixedly attached to a clamp conveying element which moves synchronously with the conveying element 300. The clamps may articulate to open and subsequently close around specific containers to limit the mobility of the container relative to the conveying element 300.

The container stabilizing element may comprise a flexible belt having regularly spaced splits which may spread apart to encircle and clamp the neck of a container. The container stabilizing element may comprises discrete clamping elements comprising resilient brushes arranges in a circular pattern and configured as part of a container clamp which descend to bring the bristles into contact with the neck of the container to stabilize the upper portion of the container with respect to conveying element 300. The clamping elements may be affixed to a secondary conveying element moving synchronously with conveying element 300. The clamping elements may be configured to descend and ascend as needed to secure and release the containers 110.

The container stabilizing element may comprise a secondary conveying element comprising a resilient belt having segmented openings corresponding to the spacing of the container receiving station and which can encircle the neck of containers as necessary to stabilize the containers with respect to conveying element 300.

In one embodiment at least one point of each container receiving location 310 is configured such that when a particular container receiving station 310 is disposed to receive a container from the transition element 200, the at least one point is disposed in about the same location relative to the transition element as in each previous iteration of being so disposed.

Conveying element 300 may comprise any container conveying means known in the art, including but not limited to, continuous belt conveyor, continuous tabletop chain conveyors, linear motor conveyors, shuttle conveyors, and other conveyor designs as are known in the art.

The container receiving stations may be configured to receive the container directly into contact with the conveying surface, or the container receiving station 310 may be augmented with a container receptacle 315 to reduce the instability of a particular container design.

In an embodiment where receptacles 315 are used to receive the plurality of containers, the flights may be positioned to reduce the mobility of the receptacle relative to the opposing pair of flights.

Subsequent to the receipt of the plurality of containers by the container conveying element 300, the containers 110 may be translated in position from the receipt position to a second container interaction position by the action of the container conveying element 300. A plurality of containers 110 may be transferred from a plurality of container receipt locations to a plurality of container interaction locations. The plurality of containers 110 translate between positions along a container path 330.

In one embodiment the secondary container interaction station may comprise a container filling element 400 disposed adjacent to the container path 330 and able to dispose a predetermined amount of a product into each of the plurality of containers 110. The filling element 400 may comprise a single filling station, or a plurality of filling stations. The filling element may fill each of the plurality of containers in a sequential manner or may fill the entirety of the plurality concurrently utilizing a plurality of filling stations. The filling element may use a mass flow meter, a volumetric flow meter or other means as are known in the art to meter the amount of the product disposed into each of the containers 10.

In one embodiment the filling element 400 may be configured to include a capping element 500 such that each of the plurality of containers 10 is filled by a filling element 400 and subsequently capped by a capping element 500 without the necessity of translating the position of the particular container 110. The capping element may place a cap upon each of the containers 110 and may apply a vertical loading force to the cap to snap it into position upon the container 110, or the capping element 500 may apply a torque to the cap to twist it into position upon the container 110.

In one embodiment the capping element 500 may be disposed at another container interaction location separate from the location of the filling element 400 and the filling and capping interactions may occur at the separate distinct locations.

In one embodiment the apparatus may further comprise a container labeling element 600. Container labeling element 600 may be disposed adjacent to the container conveying element 300. The container labeling element 600 may be disposed such that interaction with containers 110 may occur as containers are translated in location by conveying element 300, or container labeling element 600 may be disposed at a location along a secondary container conveying element 700 as illustrated in FIG. 1. The labeling element 600 may apply labels comprising pressure sensitive adhesive or other adhesives as are known in the art.

In one embodiment the apparatus 1000 comprises a container rejection element 800 to remove selected containers from a stream of a plurality of containers. The rejection element 800 may be disposed adjacent to the container path 330. The rejection element 800 may comprise a ram, pusher or other diverter mechanism as is known in the art for the purpose of redirecting a single container or multiple containers from a container conveying element.

The respective elements of the apparatus 1000 may be provided in a pre-integrated configuration. A pre-integrated configuration refers to a configuration wherein at least one aspect of each element conforms to a predetermined standard configuration. Pre-integrated elements may be integrated with fewer resources. As an example, the structural framing of the element may be pre-integrated to conform to particular mounting dimensions to allow respective elements to be attached directly frame to frame without any need for adaptive hardware. Additional aspects which may be pre-integrated include, but are not limited to, communications links, electrical power and output links, pneumatic and hydraulic supply links and container handling interface centerlines.

In one embodiment, the container forming element comprises a first container forming mold and a second container forming mold which are utilized in an alternating fashion in the formation of containers. The first and second container molds may be used in the container forming element to form substantially identical containers. Alternatively, the first and second container forming molds may be used to form containers which are not substantially identical.

As a non-limiting example, a single extrusion blow molding machine may have two discrete sets of container molds used in alternating cycles to produce blow-molded containers. The containers produced using each of the two molds are limited only by the extent to which the extruded parison may be blown up. Each of the molds may be used to produce substantially identical containers or containers having different shapes and/or sizes.

In one embodiment the container forming element may be configured such that the drive mechanism for each set of molds may operate independently of the other. In this embodiment, the container forming element may be configured with control logic that enables the container forming element to operate in a one-sided mode. In the one-sided mode, the rate of extrusion of the parison may be reduced such that the cycling of a single mold assembly is used to accept all the parisons. In this mode one side of the container forming element does not operate to form containers. The one sided mode of operation may be utilized when there is a desire to produce one of two distinct containers, to use only one of two mold assemblies, or during a time frame when it is necessary to cease the production of containers on one side of the container forming element due to issues related to internal components of the container forming element, or components of the apparatus external to the container forming element.

The containers from the first and second container forming molds may be delivered by container transfer elements to discrete packing systems as described above. Each of the discrete packing systems may comprise some or all of filling, capping and labeling elements as well as other standard packaging elements. The container forming element, together with the first and second packing systems, may concurrently yield a first product in a first container and a second product in a second container. The first container and the second container may be similar or dissimilar within the limits of the container forming element.

In one embodiment the first product in the first container and the second product in the second container may form a set of complementary products intended to be marketed together. In one embodiment, the first and second products may be provided to the consumer in a combined package. This combined package may be assembled from first and second products emerging from the first and second packing systems. As a non-limiting example, a shampoo may be packaged in a first container and a conditioner may be packaged in a second container. The shampoo and conditioner may then be combined into a unitized package.

In one embodiment, the first container and second container of the complementary products may comprise complementary containers. Complementary containers may comprise container shapes which have individual functionality and which may be combined as a pair to form a single unified shape. The single unified shape may be the result of complementary curved surfaces of the first and second containers such that the curved surfaces result in containers which nest together in pairs. The single unified shape may result from container features which combine as a protrusion and a corresponding indentation or set of corresponding protrusions and indentations. The set, or sets, of corresponding protrusions and indentations may be provided in a manner which is visible as an undulation of the interface between the pair of combined containers or in a manner which is not visible when the container pairs are combined. The single unified shape may be related to product branding indicia.

The respective pairs of containers may be joined together into a unitized package. Pairs which are joined together may be joined by using shrinkable films, flexible banding materials such as polymeric bands or paperboard bands of various weights as are known in the art.

Pairs which are retained as discrete individuals may be provided to the product retailer in a plurality of cartons with each respective carton containing a plurality of a single product of the pair. The pairs of discrete individual products may be provided to the product retailer in containers containing pairs of the two products.

In one embodiment the first containers and second containers may be substantially identical and may be filled and/or capped and/or labeled by the first and second packing systems with the same product. The containers from the first and second packing systems may be packed separately, or the containers may be combined into a single grouping of containers to be packed together. The containers may be packed according to packing means as are known in the art.

In one embodiment, the respective container mold elements may be configured such that each set of molds concurrently yields first containers and second containers. The first and second containers may be substantially identical, or may have distinct shapes and sizes. In this embodiment, the packing system may be configured to fill and/or cap the first and second containers using distinct portions of each of the filling and capping elements. As an example, in a four filling station system, filling stations one and three may fill first containers with a first product from a first product supply and filling stations two and four may fill second containers with a second product. Capping stations one and three may then cap the first containers with first product caps and capping stations two and four may cap second containers with second product caps. First product caps and second product caps may be identical or non-identical. In this embodiment the respective first and second containers may be separated into distinct container streams for the application of appropriate first and second labels. The labeled packages may be packed separately or may be recombined and packed together.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. Apparatus for producing containers, the apparatus comprising:
a) a container blow molding element, wherein the element can concurrently produce a plurality of containers, at least two adjacent containers disposed a first distance apart;
b) a container conveying element disposed adjacent to the container blow molding element, wherein the container conveying element receives the plurality of containers at predetermined container locations, wherein the predetermined container locations corresponding to the at least two adjacent containers are disposed a second distance apart, the container conveying element comprising at least one container path;
c) a transition element disposed between the container blow molding element and the container conveying element to transfer the plurality of containers from the blow molding element to the container conveying element, wherein the distance between the at least two adjacent containers is shifted from the first distance to the second distance after the plurality of containers is removed from the blow molding element and before the plurality of containers is received by the container conveying element.

2. The apparatus according to claim 1 further comprising a filling element disposed adjacent to the container path.

3. The apparatus according to claim 2 further comprising a capping element disposed adjacent to the container path.

4. The apparatus according to claim 1 further comprising a labeling element disposed adjacent to the container conveying element.

5. The apparatus according to claim 1 further comprising a plurality of container receptacles, wherein the plurality of containers are received by the container conveyor element by being deposited into the container receptacles.

6. The apparatus according to claim 3 wherein the capping element secures caps in place.

7. The apparatus according to claim 3 wherein the filling element disposes a predetermined amount of product into each container at a predetermined container location, and the capping element places a cap upon each container at the same predetermined container location.

8. The apparatus according to claim 1 further comprising a rejecting system disposed adjacent to the container path.

9. The apparatus according to claim 1 wherein the plurality of containers each comprise a container label applied during the blow molding process.

10. The apparatus according to claim 1 further comprising:
a filling element disposed adjacent to the container path,
a capping element disposed adjacent to the container path,
a labeling element disposed adjacent to the container conveying element,
a rejecting system disposed adjacent to the container path,
wherein the filling element disposes a predetermined amount of product into each container at a predetermined container location, and the capping element places a cap upon each container at the same predetermined container location.

11. A method of forming blow molded containers, the method comprising steps of:
a) blow molding a plurality of containers, the containers disposed at first predetermined locations spaced a first distance apart,
b) transferring the plurality of containers from the first predetermined locations to second predetermined locations, wherein the second predetermined locations are disposed a second distance apart.

12. The method according to claim 11 further comprising the step of applying a label to at least one of the plurality of containers as the at least one container is blow molded.

13. The method according to claim 11 further comprising the step of filling at least one of the plurality of containers after the at least one container has been transferred to the second predetermined location.

14. The method according to claim 11 further comprising the step of applying a cap to at least one of the plurality of containers after the at least one container has been transferred to the second predetermined location.

15. The method according to claim 11 further comprising the step of attaching a label to at least one of the plurality of containers after the at least one container has been transferred to the second predetermined location.

16. The method according to claim 11 further comprising the step of disposing at least one of the plurality of containers in a receptacle at the second predetermined location.

17. The method according to claim 11 further comprising the steps of
c) filling at least one of the plurality of containers at a third predetermined locations, and
d) applying a cap to the at least one of the plurality of containers at the third predetermined location.

18. A method for packaging two distinct products, the method comprising steps of:
(a) producing a first plurality of containers from one portion of a container forming element, the container forming element comprising a plurality of container forming portions,
(b) producing a second plurality of containers from a second portion of a container forming element,
(c) filling at least one of the first plurality of containers with a first product,
(d) filling at least one of the second plurality of containers with a second product.

19. The method according to claim 18 wherein at least one of the first or second plurality of containers are produced at first predetermined locations spaced a first distance apart, comprising the step of transferring the plurality of containers from the first predetermined locations to second predetermined locations spaced a second distance apart.

20. The method according to claim 18 comprising the step of combining a filled first container with a filled second container in a unitized package.
